(19) United States
(12) Patent Application Publication
(10) Pub. No.: US 2021/0049624 A1
(43) Pub. Date: Feb. 18, 2021

(54) System and Method for Identifying Prospective Entities to Interact With

(71) Applicant: The Toronto-Dominion Bank, Toronto (CA)

(72) Inventors: Christopher NEPOMUCENO, Toronto (CA); Lori-Anne CARLEY, London (CA); Bharati Kumari SETHIYA, Toronto (CA); Adam Harrison James FARR, Mississauga (CA); Andrea Darlene CLASSEN, London (CA); Anndrea CHAN, Toronto (CA)

(21) Appl. No.: 16/543,019

(22) Filed: Aug. 16, 2019

(51) Int. Cl. G06Q 30/02; G06F 16/906; G06F 16/9035; G06F 16/9038; G06F 16/909

(52) U.S. Cl. CPC G06Q 30/0203; G06F 16/906; G06F 16/909; G06F 16/9035; G06F 16/9038; G06Q 30/0201

(57) ABSTRACT

A system and method are provided for identifying prospective entities to interact with. The method is executed by a device having a processor and a display, and includes providing a user interface via the display, determining a plurality of entities located within a geographic area, and filtering the plurality of entities using one or more filtering criteria to determine a subset of entities that correspond to a selected type of entity. The method also includes obtaining information corresponding to each of the subset of entities; using the information corresponding to the subset of entities to determine, for each entity, a ranking of being a prospective entity to interact with; identifying one or more of the subset of entities in the user interface, in association with the geographic area; and enabling contact to be initiated with a selected one of the one or more of the subset of entities.

### TECHNICAL FIELD

The following relates generally to identifying prospective entities to interact with.

### BACKGROUND

Commercial enterprises such as retailers, service providers, and financial institutions may rely on targeting prospective entities such as customers, consumers, clients, and partners; for example, to establish connections and provide goods and/or services to those entities. However, individuals such as managers or other employees that are tasked with targeting such entities may be required to spend a significant amount of time to search for, research, and connect with these entities.

Moreover, in many of the commercial enterprises, specialized tools or subscription services may be provided to the employees via in-office resources, e.g., using desktop computers connected into the enterprise systems. This can make it difficult for employees to quickly and efficiently target prospects or determine if the prospects have been contacted before, are existing clients, etc., particularly in an increasingly mobile workplace.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of a client targeting platform.

FIG. 3 is a block diagram of an example configuration of an employee device.

FIG. 4 is an example of a graphical user interface displaying prospective client entities in a geographic area.

FIG. 5 is an example of a graphical user interface displaying client and market information for a prospective client entity.

FIG. 6 is an example of a graphical user interface displaying an example set of questions for sending to a prospective client entity.

FIG. 7 is a flow diagram of an example of computer executable instructions for identifying prospective entities to interact with.

FIG. 8 is a flow diagram of an example of computer executable instructions for using a client targeting platform and employee device to identify prospective clients to interact with and initiating a communication with a prospective client device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Individuals such as employees that identify and target individuals to interact with, e.g., for pursuing new business opportunities, would benefit from an application or service that can assist with identifying prospective clients by accessing internal and/or external sources of information. An application may be provided to identify and visually present information to an individual to avoid potentially significant time and effort normally required to research, identify, and target prospective entities. The application may provide location-based information and additional statistical information and enable the individual user to initiate contact with prospective entities via the application. The application can be provided via a mobile application, and the mobile application can interact with and/or rely on a server-based platform that is associated with a commercial enterprise.

Certain example systems and methods described herein enable the identification of prospective entities with which to interact and enable further information to be obtained for and communications to be initiated with such entities. In one aspect, there is provided a device for identifying prospective entities to interact with. The device includes a processor, a display coupled to the processor, a communications module coupled to the processor, and a memory coupled to the processor. The memory stores computer executable instructions that when executed by the processor cause the processor to provide a user interface via the display, determine a plurality of entities located within a geographic area, and filter the plurality of entities using one or more filtering criteria to determine a subset of entities that correspond to a selected type of entity. The computer executable instructions when executed by the processor further cause the processor to obtain via the communications module, information corresponding to each of the subset of entities; use the information corresponding to the subset of entities to determine, for each entity, a ranking of being a prospective entity to interact with; identify one or more of the subset of entities in the user interface, in association with the geographic area; and enable contact to be initiated with a selected one of the one or more of the subset of entities via the communications module.

In another aspect, there is provided a method of identifying prospective entities to interact with. The method is executed by a device having a processor and a display and includes providing a user interface via the display, determining a plurality of entities located within a geographic area, and filtering the plurality of entities using one or more filtering criteria to determine a subset of entities that correspond to a selected type of entity. The method also includes obtaining information corresponding to each of the subset of entities; using the information corresponding to the subset of entities to determine, for each entity, a ranking of being a prospective entity to interact with; identifying one or more of the subset of entities in the user interface, in association with the geographic area; and enabling contact to be initiated with a selected one of the one or more of the subset of entities.

In another aspect, there is provided non-transitory computer readable medium for identifying prospective entities to interact with. The computer readable medium includes computer executable instructions for providing a user interface via a display, determining a plurality of entities located within a geographic area, and filtering the plurality of entities using one or more filtering criteria to determine a subset of entities that correspond to a selected type of entity. The computer executable instructions also include instructions for obtaining via a communications module, information corresponding to each of the subset of entities; using the information corresponding to the subset of entities to determine, for each entity, a ranking of being a prospective entity to interact with; identifying one or more of the subset of entities in the user interface, in association with the geographic area; and enabling contact to be initiated with a selected one of the one or more of the subset of entities via the communications module.

In certain example embodiments, the user interface may include a map portion, and the device may display at least a portion of the geographic area in the map portion of the user interface.

In certain example embodiments, the device may communicate with a selected one of the subset of entities via the communications module. The device may send a list of one or more questions for the selected one of the subset of entities, and the list of one or more questions can be provided using a questionnaire generated based on an analysis of the information corresponding to the selected one of the subset of entities.

In certain example embodiments, obtaining information corresponding to each of the subset of entities may include searching at least one internal database for a match with an entity having an existing relationship, and searching at least one external database when no match is found using the at least one internal database.

In certain example embodiments, the prospective entities to interact with may include prospective clients for which to provide at least one product or service.

In certain example embodiments, the one or more of the subset of entities is identified in the map portion of the user interface. The one or more of the subset of entities may also be identified by providing a list. The list may be ordered according to the ranking associated with the respective entity.

In certain example embodiments, the device may be a mobile device, the user interface can use a geolocating tool to associate the plurality of entities with the geographic area, and the user interface can use a mapping tool to obtain information for displaying the map portion. The device may also detect a location input from which the geographic area is determined, or automatically detecting a mobile device location from which the geographic area is determined.

In certain example embodiments, the device may display the information corresponding to the subset of entities after detecting selection of an option to access the information.

In certain example embodiments, the ranking can include a quantitative value. The quantitative value can be determined using a model, the model being generated using a machine learning algorithm. For mobile devices, the ranking may be performed at a server device in communication with the mobile device via the communications module.

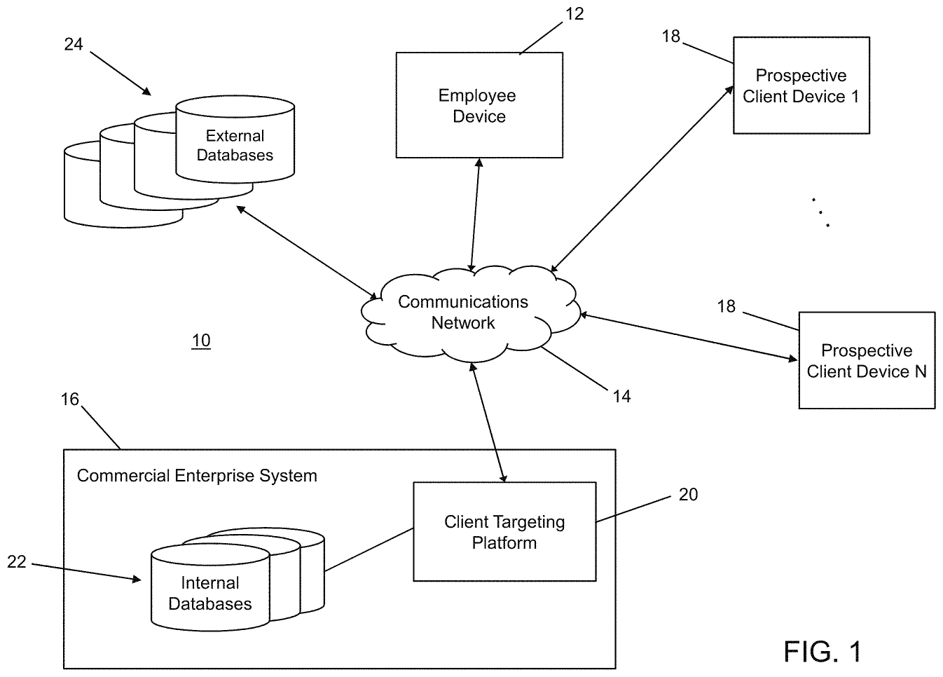

FIG. 1 illustrates an exemplary computing environment 10 in which an employee device 12 communicates with a client targeting platform 20 over a communications network 14 to identify prospective entities to interact with. In this example configuration, the prospective entities have corresponding prospective client devices 18, hereinafter also referred to as “client devices” 18. The employee device 12 can be a mobile communications device used by an employee of a commercial enterprise system 16. The commercial enterprise system 16 can be the employer of the user of the employee device 12 or may have a long- or short-term contractual relationship with the user, wherein the user acts on behalf of the enterprise entity to target the prospective entities for the commercial enterprise system 16. It can be appreciated that the employee/commercial-enterprise/client terminology used herein is for illustrative purposes and the principles described herein can equally apply to various other commercial environments with respective employment or remuneration arrangements and client/consumer/customer types.

In the example configuration shown in FIG. 1, the commercial enterprise system 16 includes the client targeting platform 20 within its system. However, it can be appreciated that the client targeting platform 20 may also be provided as a standalone entity, such as an independent service that can communicate with multiple commercial enterprise systems 16. The client targeting platform 20 can therefore include one or more devices such as servers capable of communicating with the network 14 and with the commercial enterprise system 16. Details of the commercial enterprise system 16 are omitted for ease of illustration and it will be appreciated that the commercial enterprise system 16 can be associated with a variety of business types, such as financial institutions, retailers, professional service providers, government enterprises, social media enterprises, etc. The commercial enterprise system 16 typically includes one or more internal databases 22. The internal databases 22 can be associated with proprietary and internally governed applications and services, or may correspond to a database, log, or record keeping functionality used within the commercial enterprise system 16. As shown in FIG. 1, the client targeting platform 20 has access to the internal databases 22 to obtain internal information of the commercial enterprise system 16. For example, the client targeting platform 20 may access an internal client database or a log of previously searched and/or contacted prospects. If the client targeting platform 20 is external or independent of the commercial enterprise system 16, the client target platform 20 may be required to obtain credentials to access such internal databases 22.

The devices shown in FIG. 1 have access to one or more external databases 24 via the network 14. The external databases 24 may include any source of publicly available information (whether free and/or subscription-based), such as websites, social media profiles, corporate or government registries, business association databases, etc. Such external databases 24 may be accessed via an Internet or other remote data connection such as an application programming interface (API). As discussed in greater detail below, the external databases 24 can also include geolocating and mapping data and/or global positioning system (GPS) data made available to the devices 12, 18, 20. While omitted from FIG. 1 for the sake of clarity, any of the external databases 24 may be associated with a device such as a server, a service, or other system that manages, updates, and provides access to the external information.

In certain aspects, employee device 12 and/or prospective client device 18 can include, but is not limited to, a mobile data communication device and these may include a mobile or smart phone, a laptop computer, a tablet computer, a notebook computer, a hand-held computer, a personal digital assistant, an embedded device, a virtual reality device, an augmented reality device, third party portals, a personal computer, and any additional or alternate computing device, and may be operable to transmit and receive data across communication network 14.

Communication network 14 may include a telephone network, cellular, and/or data communication network to connect different types of devices as will be described in greater detail below. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The computing environment 10 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the employee device 12, prospective client device 18, client targeting platform 20, and commercial enterprise system 16. The cryptographic server may be used to protect the data or results of the data by way of encryption for data protection, digital signatures or message digests for data integrity, and by using digital certificates to authenticate the identity of the users and devices within the computing environment 10, to inhibit data breaches by adversaries. It can be appreciated that various cryptographic mechanisms and protocols can be chosen and implemented to suit the constraints and requirements of the particular deployment of the computing environment 10 as is known in the art.

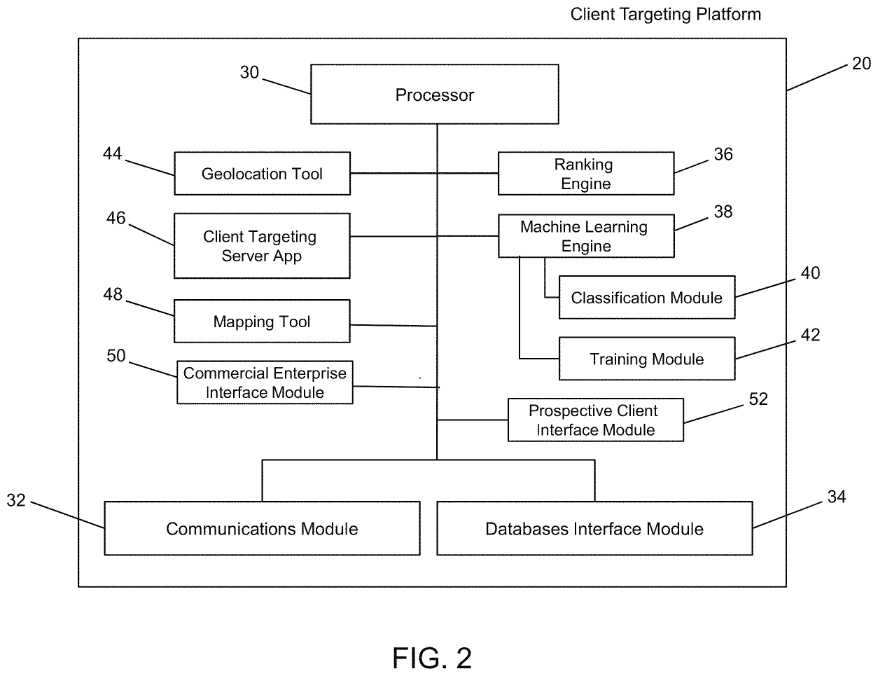

In FIG. 2, an example configuration of the client targeting platform 20 is shown. In certain embodiments, the client targeting platform 20 may include one or more processors 30, a communications module 32, and a databases interface module 34 for interfacing with the internal databases 22 to retrieve and store data in the commercial enterprise system 16. Communications module 32 enables the client targeting platform 20 to communicate with one or more other components of the computing environment 10, such as employee devices 12, client devices 18, and external databases 24, via a bus or other communication network, such as the communication network 14. While not delineated in FIG. 2, the client targeting platform 20 includes at least one memory or memory device that can include a tangible and non-transitory computer-readable medium having stored therein computer programs, sets of instructions, code, or data to be executed by processor 30. FIG. 2 illustrates examples of modules, tools and engines stored in memory on the client targeting platform 20 and operated by the processor 30. It can be appreciated that any of the modules, tools, and engines shown in FIG. 2 may also be hosted on the employee device 12. That is, it can be appreciated that the client-server relationship exemplified in FIG. 1 can also be rearranged to be hosted individually on the employee device 12. The level of processing responsibility can be varied according to the capabilities of the employee device 12, commercial enterprise system 16, or client targeting platform 20 (when utilized), or requirements of the application, industry, or computing environment 10.

In the example embodiment shown in FIG. 2, the client targeting platform 20 includes a ranking engine 36 for analyzing and evaluating prospective entities. As discussed further below, the ranking engine 36 may be used to assign a quantitative measure, score, or other value to enable the prospects to be filtered and ranked as potential prospects. In the configuration shown in FIGS. 1 and 2, the client targeting platform 20 operates the ranking engine 36 on behalf of the employee device 12 and therefore may also have access to the external databases 24 via the communications module 32.

The client targeting platform 20 may also include a machine learning engine 38, a classification module 40, a training module 42, a geolocation tool 44, a client targeting server app 46, a mapping tool 48, a commercial entity interface module 50, and a prospective client interface module 52.

The machine learning engine 38 is used by the ranking engine 36 to generate and train models to be used in evaluating the internal and/or external information associated with the prospective clients for a particular search. The ranking engine 36 may utilize or otherwise interface with the machine learning engine 38 to both classify data currently being analyzed to generate the models, and to train classifiers using data that is continually being processed and accumulated by the employee devices 12, commercial enterprise system 16, and client targeting platform 20.

The machine learning engine 38 may also perform operations that classify the data from the internal and external databases 22, 24 in accordance with corresponding classifications parameters, e.g., based on an application of one or more machine learning algorithms to the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved using, elements of previously classified profile content identifying expected datapoints. Subsequent to classifying the data, the machine learning engine 38 may further process each data point to identify, and extract, a value characterizing the corresponding one of the classification parameters, e.g., based on an application of one or more additional machine learning algorithms to each of the data points. By way of the example, the additional machine learning algorithms may include, but are not limited to, an adaptive natural language processing algorithm that, among other things, predicts starting and ending indices of a candidate parameter value within each data point, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified data. Classification parameters may be stored and maintained using the classification module 40, and training data may be stored and maintained using the training module 42.

In some instances, classification data stored in the classification module 40 may identify one or more parameters, e.g., “classification” parameters, that facilitate a classification of corresponding elements or groups of recognized data points based on any of the exemplary machine learning algorithms or processes described herein. The one or more classification parameters may correspond to parameters that can identify expected and unexpected data points for certain types of data.

In some instances, the additional, or alternate, machine learning algorithms may include one or more adaptive, natural-language processing algorithms capable of parsing each of the classified portions of the data being examined and predicting a starting and ending index of the candidate parameter value within each of the classified portions. Examples of the adaptive, natural-language processing algorithms include, but are not limited to, natural-language processing models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between a data point and a single classification parameter and additionally, or alternatively, multiple classification parameters.

Based on the output of the one or more machine learning algorithms or processes, such as the one-dimensional, convolutional neural network model described herein, machine learning engine 38 may perform operations that classify each of the discrete elements of the internal and/or external data being examined as a corresponding one of the classification parameters, e.g., as obtained from classification data stored by the classification module 40.

The outputs of the machine learning algorithms or processes may then be used by the ranking engine 36 to generate and train models and to use such models to determine a ranking for a subject prospective entity. The ranking engine 36 may also use a set of rules, a weighted formula or any other statistical or mathematical function or tool to evaluate information related to a prospective client.

Referring again to FIG. 2, the client targeting server app 46 may be used to provide one or more outputs based on the results generated by the ranking engine 26. Example outputs include a visual output that can be displayed by the employee device 12 in a graphical user interface (GUI) or other data that enables the employee device 12 to generate such a GUI. The geolocation tool 44 may be used by the client targeting platform 20 to identify geolocation data associated with entities in a geographic area. For example, the employee device 12 may report its current location or a specified location to the client targeting server app 46, which can be used to initiate the geolocation tool 44 to find businesses and other entities within the associated geographic area such as within a predetermined or specified distance from a location.

The mapping tool 48 may also be used by the client targeting platform 20 to obtain or generate mapping data associated with the geographic area. For example, when searching for businesses within the geographic area, the mapping tool 48 may be used to generate a visual map on which identifiers of located entities can be displayed. It can be appreciated that the geolocation tool 44, client targeting server app 46, and mapping tool 48 are shown as being delineated in FIG. 2 for illustrative purposes only and the associated functionality may also be integrated into the client targeting server app 46. Similarly, the geolocation tool 44 and mapping tool 48 may be integrated into the same location-based application or service. The geolocation tool 44 and/or mapping tool 48 may also be provided by one or more third party APIs that are accessed by the client targeting server app 46 to integrate geolocating and mapping services. The client targeting server app 46 may also include web browsing or other internet browsing or searching capabilities or may have access to a web browser app (not shown), in order to access the external databases 24.

The commercial enterprise interface module 50 provides one or more interfaces to the commercial enterprise system 16, e.g., to enable the client targeting platform 20 to access data from the internal databases 22. The commercial enterprise interface module 50 can also be used to access or otherwise interact with or communicate with internal programs, devices, or systems of the commercial enterprise system 16 that can provide any suitable information associated with an existing or potential client. The commercial enterprise interface module 50 can utilize the databases interface module 34 to obtain data from internal databases 22. As such, the databases interface module 34 is shown in FIG. 2 for illustrative purposes and the functionality thereof may be provided by the commercial enterprise interface module 50 or the client targeting server app 46.

The prospective client interface module 52 is shown in FIG. 2 for illustrative purposes and the functionality thereof may be provided from within the client targeting server app 46 or by an app, program or module on the employee device 12 as discussed below. The prospective client interface module 52 enables the client targeting platform 20 on behalf of the employee device 12 (or the employee device 12 itself), to initiate a communication with prospective client devices 18 and thereafter communicate with the associated user via the client device 18, e.g., to complete a questionnaire, arrange a further discussion, provide additional details or links to potential products or services, or to initiate a process provided by the commercial enterprise system 16 to have a prospective client become a new client.

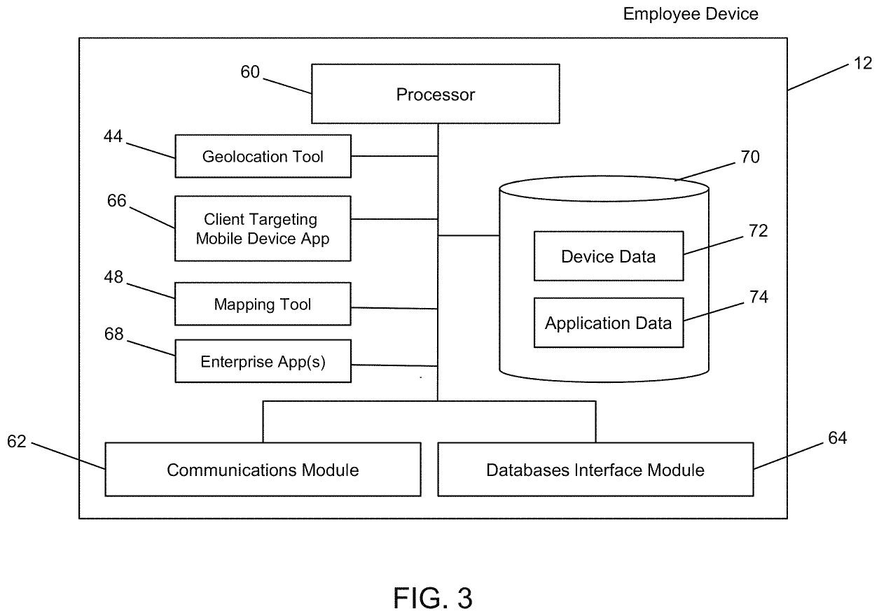

In FIG. 3, an example configuration of the employee device 12 is shown. In certain embodiments, the employee device 12 may include one or more processors 60, a communications module 62, a databases interface module 64, a client targeting mobile device app 66, and a data store 70 storing device data 72 and application data 74. Communications module 62 enables the employee device 12 to communicate with one or more other components of the computing environment 10, such as the client targeting platform 20, commercial enterprise system 16, and client devices 18 (or one of its components), via a bus or other communication network, such as the communication network 14. While not delineated in FIG. 3, the employee device 12 includes at least one memory or memory device that can include a tangible and non-transitory computer-readable medium having stored therein computer programs, sets of instructions, code, or data to be executed by processor 60. FIG. 3 illustrates examples of modules and applications stored in memory on the employee device 12 and operated by the processor 60. It can be appreciated that any of the modules and applications shown in FIG. 3 may also be hosted externally by the client targeting platform 20 (as discussed above) and be available to the employee device 12, e.g., via the communications module 62. It can be appreciated that the databases interface module 64 is shown in FIG. 3 for illustrative purposes only and the functionality thereof may also be provided by the communications module 62, e.g., when the external databases 24 are available via a connection to the communications network 14. The databases interface module 64 may also include functionality that enables the client targeting mobile device app 66 to obtain data from the internal databases 22, via the client targeting platform 20.

In the example embodiment shown in FIG. 3, the employee device 12 includes the client targeting mobile device app 66 for enabling the user of the device 12 to initiate and operate a program to identify, target, and interact with prospective clients. The client targeting mobile device app 66 may include a display module for rendering GUIs and other visual output on a display device such as a display screen, and an input module for processing user or other inputs received at the employee device 12, e.g., via a touchscreen, input button, transceiver, microphone, keyboard, etc. The employee device 12 may also include the geolocation tool 44 and/or the mapping tool 48 used by the client targeting server and mobile device apps 46, 66. It can be appreciated that the geolocation tool 44 and mapping tool 48 are shown in both FIGS. 2 and 3 to illustrate that such services may be available to both the client- and server-based applications 46, 66 for use in mapping geographic areas and identifying geolocated entities in a map interface. The geolocation and mapping data may therefore be obtained and used by either or both the mobile device app 66 and server app 46, and such data can be shared between them.

Similarly, the employee device 12 may include one or more enterprise apps 68 provided by the commercial enterprise system 16, which is their employer in this example configuration. The employee device 12 may also include other applications not shown in FIG. 3, such as a web browser application for accessing Internet-based content, e.g., via a mobile or traditional website. The data store 70 may be used to store device data 72, such as, but not limited to, an IP address or a MAC address that uniquely identifies employee device 12 within environment 10. The data store 70 may also be used to store application data 74, such as, but not limited to, login credentials, user preferences, cryptographic data (e.g., cryptographic keys), etc.

It will be appreciated that only certain modules, applications, tools and engines are shown in FIGS. 2 and 3 for ease of illustration and various other components would be provided and utilized by the employee device 12 and client targeting platform 20 as is known in the art. It will also be appreciated that the configuration of the client devices 18 may be similar to that shown in FIG. 2 or 3, including a communication application that enables the employee device 12 and/or the client targeting platform 20 to interact with the user of the client device 18.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the employee device 12, client device 18, commercial enterprise system 16, client targeting platform 20, internal databases 22, external databases 24, or accessible or connectable thereto. Any application or module herein described may be implemented using computer readable/executable instructions that may be stored or otherwise held by such computer readable media.

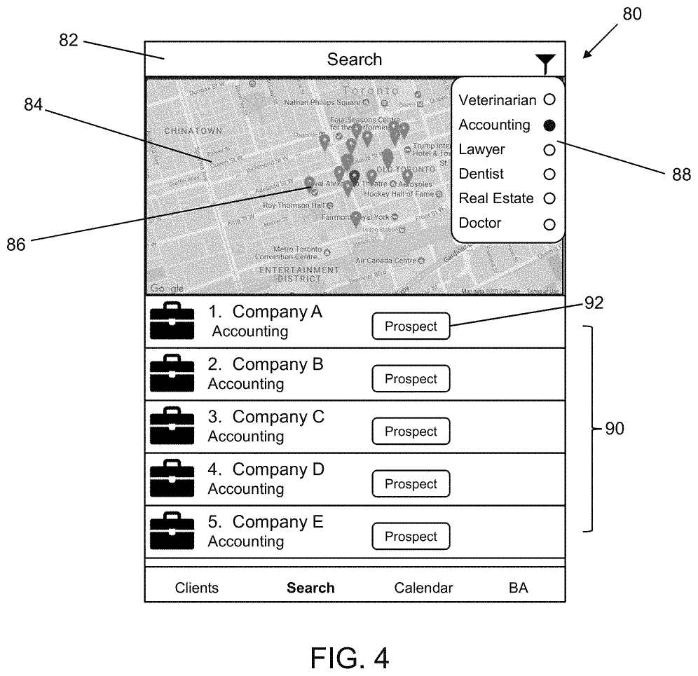

Referring to FIG. 4, a screen shot of an example of a GUI 80 for the client targeting mobile device app 66 is shown. In the example shown in FIG. 4, a search page 82 of the GUI 81 is being displayed by the employee device 12. The search page 82 enables the user of the employee device 12 locate and target prospective clients by levering the external databases 24 and, when applicable, the internal databases 22. The mobile device app 66 also enables the user to be accessible and productive without necessarily being present within physical premises of the commercial enterprise system 16. The interactivity between the employee device 12 and the client targeting platform 20 allows the user to leverage aggregated data from multiple sites to reduce the amount of time required to search, locate, engage, and interact with such prospective clients. It can be appreciated that for any of the features and functions of the GUI 80 described below, either or both the employee device 12 and the client targeting platform 20 can be responsible for obtaining data, rendering a visual output to be displayed, and handling communications between devices and entities.

In the search page 82 shown in FIG. 4, a map portion 84 is provided, which may use the mapping tool 48 to render a map of a geographic area. The geographic area can be associated with a current location of the employee device 12 (e.g., as determined by a GPS or similar application), or can be based on a selected, provided, or predetermined location. For example, a user may wish to connect with local prospects and simply rely on their current location in one scenario, but in another scenario may wish to target prospects in a particular region while traveling in an entirely different region. The map portion 84 can also be used to provide a series of indicators 86 for each of a plurality of located entities. The geolocating tool 44 can be used to correlate address or location data for an entity with the region being shown in the map portion 84, and the indicators populated accordingly. The number and type of indicators 86 can vary from any and all entities, to a filtered subset of relevant prospects, to an even further filtered subset that meets a particular ranking threshold or has a particular minimum score. The indicators 86 can also be color coded to distinguish between filtered and non-filtered results, or to distinguish between different ranking levels, such as strong leads versus general prospects that fit a minimum set of criteria.

In the example shown in FIG. 4, the subset of indicators 86 that is displayed in the map portion 84 may be automatically selected based on one or more filters or filtering criteria. As illustrated in FIG. 4, a type of entity can be selected from a filtering tool 88 that, in this example, lists “Veterinarian”, “Accounting”, Lawyer”, “Dentist”, “Real Estate”, and “Doctor” as potential filters, in order to target a specific type of prospect. In addition to a type of business being targeted, the GUI 80 can apply other filters that evaluate or analyze the filtered entities by ranking the entity using the ranking engine 36. The ranking can include assigning a quantitative score or ranking value that is determined by the ranking engine 36. The ranking or score can be based on a set of weights applied to certain filtering criteria such as size of business, type of industry, size of market, geographical market(s), revenues, growth rate, profits, related entities, etc. That is, any information available to the client targeting platform 20 and employee device 12 can be used to curate and filter the search results presented to the user. In the example shown in FIG. 4, a list prospects 90 of a subset of the prospects can be displayed along with the map portion 84 to identify the most promising or otherwise more highly ranked or rated prospects. In this way, the user can conduct a search to identify a broad category of prospective clients while the system described herein operates to locate, evaluate, rank, and display relevant results.

The list of prospects 90 can include some basic information such as the name of the entity and the type of business as well as a link or option 92 to obtain additional prospect details. It can be appreciated that the list of prospects 90 can include all prospects ordered by relevance or ranking or can include only a filtered list of the best prospects according to the ranking process. The list of prospects 90 can also be selectable directly from the map portion 84 and thus it can be appreciated that the visual layout of the search page 82 shown in FIG. 4 is illustrative and should not be considered limiting.

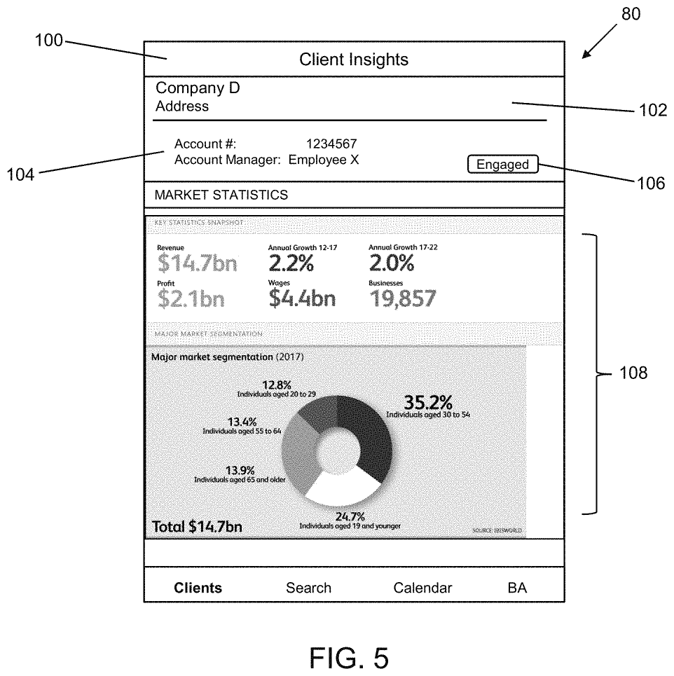

Turning now to FIG. 5, a client insights page 100 of the GUI 80 is shown. In this example, a prospective client has been selected and the page 100 displayed to illustrate further details and information 102 relevant to that client. In the example shown in FIG. 5, the prospect is Company D from the list of prospects 90 shown in FIG. 4. While Company D is a prospect and was listed in the search results, this example shows that an existing client of the commercial enterprise system 16 may also be a prospective client, e.g., for another product or service or as a renewed or repeat customer. In this example, an engaged tag 106 is provided, along with customer data 104 such as the existing account number and account manager. This allows the user of the employee device 12 conducting the current search to gain insights into potential business for existing clients as well as unknown or otherwise new prospective clients. In addition to the company details, the page 100 can include a market statistics portion 108 to provide market-related information and data that is associated with the potential prospect.

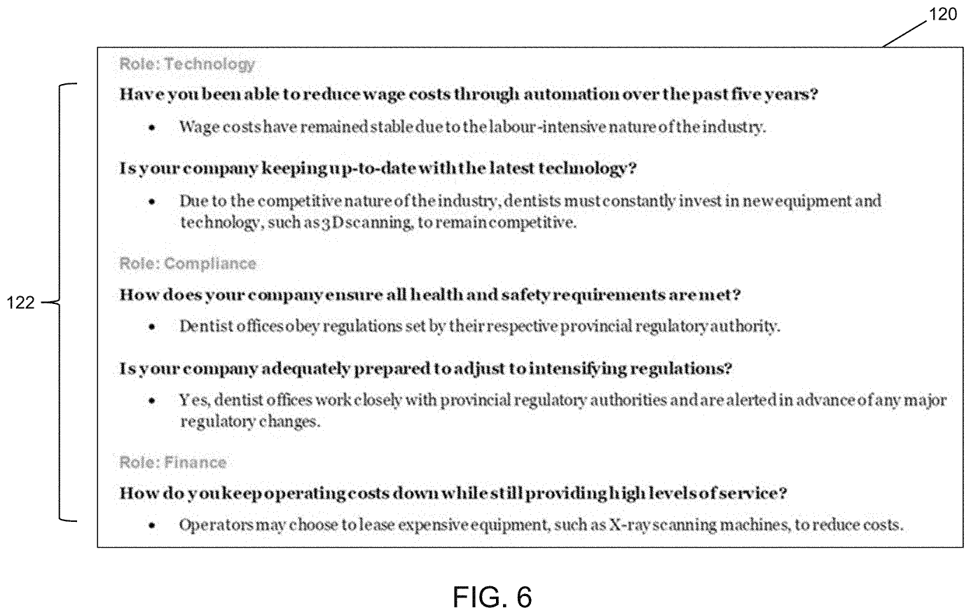

From the client insights page 100 or another menu within the GUI 80, the user can initiate a communication or interaction with the prospective client. For example, as illustrated in FIG. 6, an industry-specific questionnaire 120 can be created or obtained from a pre-generated document. The questionnaire can include questions 122 and/or statistics related to the analysis of the information gathered form the internal databases 22 and external databases 24. FIG. 6 illustrates an example of a questionnaire that is targeted at dentists by a commercial enterprise system 16 that is or relates to a financial institution where potential lease or loan opportunities may exist. The questionnaire shown in FIG. 6 has been completed by a prospective client and can be sent and received in any suitable format, including electronic messages or web-based forms.

In addition to the questionnaire shown in FIG. 6, the user can choose to engage the prospective client through a traditional communication medium such as telephone, email, text, message, or social media post to name a few. The list of prospective client 90 can be saved to enable the user of the employee device 12 to review the results and potentially initiate a communication with multiple prospective clients at different times and/or to enable the user to run and keep multiple search results at the same time.

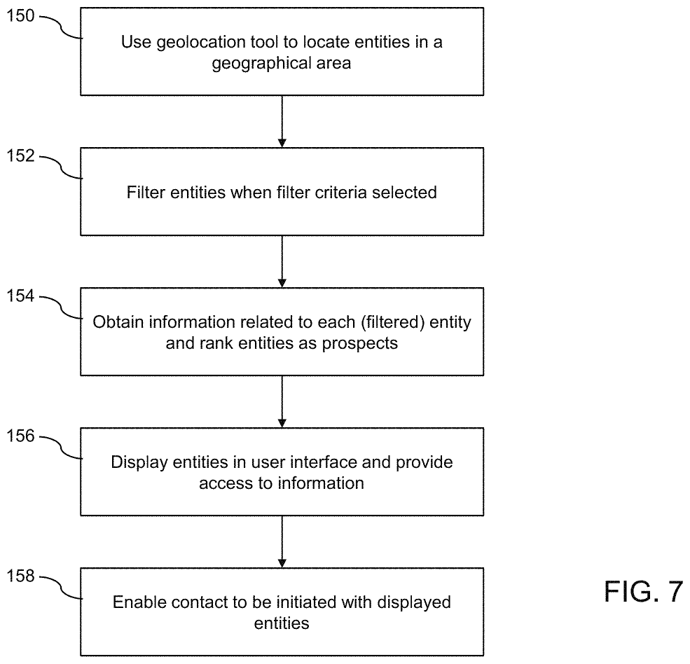

Referring to FIG. 7, an example embodiment of computer executable instructions for identifying prospective entities to interact with is shown. In the following, the “system” will generally refer to either or both the employee device 12 and the client targeting platform 20 working individually or together to perform the described operation. At block 150, the system uses the geolocation tool 44 to locate entities in a geographic area. As indicated above, this can be related to a current device location or a selected or defined geographic area. The geolocation tool 44 can be part of a third-party location-based service that maintains details of entities such as homes and businesses for mapping, navigation, and other services.

At block 152, the entities that are identified by the geolocation tool 44 can be filtered when one or more filtering criteria are selected. The filtering can occur as an input to the geolocation tool 44 or can be applied after receiving a bulk set of results that is based only on location.

At block 154, the system has a set of entities that may have been filtered to target a type of entity and gathers and aggregates both internal and external information by accessing the internal databases 22 and external databases 24 as further described below. The information that is gathered and aggregated may then be analyzed by the ranking engine 36 to rank the entities as potential prospects. As discussed above, the ranking can be used to further filter the results that are displayed, to order the list of prospects 90 in the GUI 80, or to at least distinguish between results by identifying the entity by their ranking, using variations to the indicators 86 or visual elements included in the list of prospects 90.

At block 156, the entities identified in blocks 152 and 154 may be displayed in the GUI 80 and access to further information for the entities provided. An example of the entities being displayed (and such further information provided) is shown in FIGS. 4 and 5 described above. In this way, the user of the employee device 12 can quickly and efficiently search for and identify suitable targets and avoid unrelated or undesirable prospects that could consume significant time and resources. The user of the employee device 12 can also be armed with relevant information for the prospective clients that can be used to prioritize those with which the user engages and interacts. The system described herein leverages the ability to access both internal and external sources of information to identify potentially overlapping relationships within an organization (to avoid or embrace) and provide significant context before engaging the entities.

At block 158, the system enables contact to be initiated with one of the displayed entities, e.g., by providing access to contact information or a link to immediately initiate the communication. The contact being initiated at block 158 can also include media such as questionnaires as illustrated in FIG. 6.

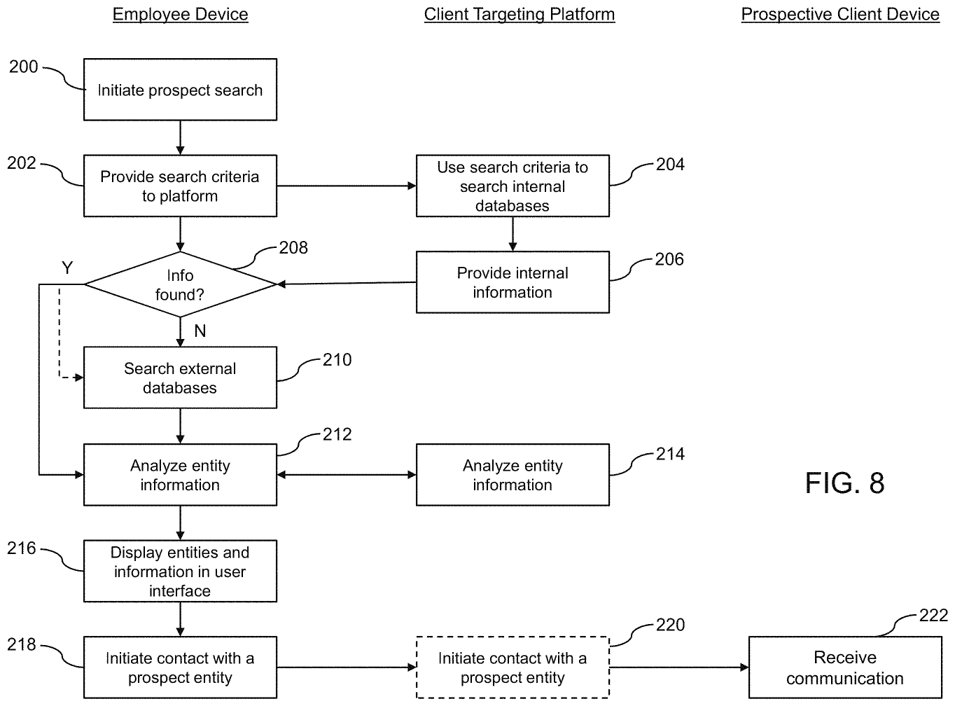

Referring to FIG. 8, an example embodiment of computer executable instructions for utilizing the employee device 12 and client targeting platform 20 to identify prospective entities to interact with, is shown. At block 200, a prospect search is initiated at the employee device 12, e.g., using the GUI 80 of the client targeting mobile device app 66. At block 202, the device app 66 provides search criteria to the server app 46 at the client targeting platform 20. This enables the client targeting platform 20 to use the search criteria to search the internal databases 22 for relevant information at block 204.

At block 206, when internal information is located, it may be provided and returned to the employee device 12. At block 208, the employee device 12 determines whether any internal information has been found. The presence or absence of internal information may impact whether external information is needed and how to identify the prospective client, particularly if they are an existing or previous client of the commercial enterprise system 16. Several example scenarios can arise, as follows:

Scenario 1—no internal information is found. In this scenario, the entity is likely unknown to the commercial enterprise system 16 and external information would be needed to further evaluate the applicability of that entity as a prospective client.

Scenario 2A—internal information has been found for a suitable existing or previous client. In this scenario, the system may determine that while the client is an existing client, there is at least one potential opportunity for new or repeat business.

Scenario 2B—internal information has been found for an unsuitable existing or previous client. In this scenario, the system may determine that the existing client relationship is sufficient and may exclude this entity as a prospective client.

Scenario 2C—internal information has been found related to a previous search. In this scenario, while the entity is not an existing or previous client, the entity is known to the system and this could increase or decrease the relevance and ranking of the entity based on the previous attempt. For example, if the entity was previously identified as a strong prospect but was unresponsive, this could weigh against the ranking for that entity.

Scenario 3—internal information has been found that generally relates to the entity without being engaged in a business activity. In this scenario, the commercial enterprise system 16 may have sources of information that can identify the entity and would not necessarily be available in external databases 24.

Scenario 4—internal information has been found but may be incomplete or out of date. In this scenario, while internal information has been located, the system may determine that both internal and external sources should be analyzed to provide additional accuracy or context.

At block 208 if no internal information has been found (e.g., Scenario 1 listed above), the employee device 12 can proceed to search the one or more external databases 24 at block 210, e.g., using a web browser, app, or other tool that can access the external databases 24 via the communications network 14. At block 208, if internal information has been found (e.g., Scenarios 2-4 listed above), the employee device 12 may proceed to analyze the entity information at block 212, or may first gather any suitable external information at block 210 as shown in dashed lines in FIG. 8 and explained in detail above. At block 214, the analyzing of the entity information in the example configuration shown and described herein also includes the client targeting platform 20, e.g., using the ranking engine 36. It can be appreciated that blocks 212 and 214 may include several exchanges of information and any suitable division of processing labor to filter, rank, and organize the entities that will be displayed on the employee device 12. It can also be appreciated that block 212 may instead include sending information (e.g., external information gathered by the employee device 12) to the client targeting platform 20, i.e., wherein the analysis is conducting solely or primarily on the client targeting platform 20.

At block 216, the employee device 12 displays the entities and the information in the GUI 80, examples of which are explained and exemplified above. At block 218, the employee device 12 detects the initiation of contact with a prospective entity, e.g., by communicating with, preparing a questionnaire for, etc. As shown in dashed lines in FIG. 8, block 220 may optionally include use of the client targeting platform 20 to initiate or implement the contact with the prospective entity. For example, the client targeting platform 20 may provide a form builder to create and send a questionnaire. At block 222, the client device 18 associated with the prospective client receives the communication.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for identifying prospective entities to interact with, the device comprising:
a processor;
a display coupled to the processor;
a communications module coupled to the processor; and
a memory coupled to the processor, the memory storing computer executable instructions that when executed by the processor cause the processor to:
provide a user interface via the display;
determine a plurality of entities located within a geographic area;
filter the plurality of entities using one or more filtering criteria to determine a subset of entities that correspond to a selected type of entity;
obtain via the communications module, information corresponding to each of the subset of entities;
use the information corresponding to the subset of entities to determine, for each entity, a ranking of being a prospective entity to interact with;
identify one or more of the subset of entities in the user interface, in association with the geographic area; and
enable contact to be initiated with a selected one of the one or more of the subset of entities via the communications module.

2. The device of claim 1, wherein the user interface comprises a map portion, and the computer executable instructions further cause the processor to:
display at least a portion of the geographic area in the map portion of the user interface.

3. The device of claim 1, wherein the computer executable instructions further cause the processor to:
communicate with a selected one of the subset of entities via the communications module.

4. The device of claim 3, wherein the device sends a list of one or more questions for the selected one of the subset of entities.

5. The device of claim 4, wherein the list of one or more questions is provided using a questionnaire generated based on an analysis of the information corresponding to the selected one of the subset of entities.

6. The device of claim 1, wherein obtaining information corresponding to each of the subset of entities further causes the processor to:
search at least one internal database for a match with an entity having an existing relationship; and
search at least one external database when no match is found using the at least one internal database.

7. The device of claim 1, wherein the prospective entities to interact with comprise prospective clients for which to provide at least one product or service.

8. The device of claim 2, wherein the one or more of the subset of entities is identified in the map portion of the user interface.

9. The device of claim 1, wherein the one or more of the subset of entities is identified by providing a list.

10. The device of claim 9, wherein the list is ordered according to the ranking associated with the respective entity.

11. The device of claim 1, wherein the device comprises a mobile device, the user interface uses a geolocating tool to associate the plurality of entities with the geographic area, and the user interface uses a mapping tool to obtain information for displaying the map portion.

12. The device of claim 11, wherein the computer executable instructions further cause the processor to:
detect a location input from which the geographic area is determined; or
automatically detect a mobile device location from which the geographic area is determined.

13. The device of claim 1, wherein the computer executable instructions further cause the processor to:
display the information corresponding to the subset of entities after detecting selection of an option to access the information.

14. The device of claim 1, wherein the ranking comprises a quantitative value.

15. The device of claim 14, wherein the quantitative value is determined using a model, the model being generated using a machine learning algorithm.

16. The device of claim 15, wherein the device comprises a mobile device, and the ranking is performed at a server device in communication with the mobile device via the communications module.

17. A method of identifying prospective entities to interact with, the method executed by a device having a processor and a display, and comprising:
providing a user interface via the display;
determining a plurality of entities located within a geographic area;
filtering the plurality of entities using one or more filtering criteria to determine a subset of entities that correspond to a selected type of entity;
obtaining information corresponding to each of the subset of entities;
using the information corresponding to the subset of entities to determine, for each entity, a ranking of being a prospective entity to interact with;
identifying one or more of the subset of entities in the user interface, in association with the geographic area; and
enabling contact to be initiated with a selected one of the one or more of the subset of entities.

18. The method of claim 17, wherein obtaining information corresponding to each of the subset of entities further comprises:
searching at least one internal database for a match with an entity having an existing relationship; and
searching at least one external database when no match is found using the at least one internal database.

19. The method of claim 17, further comprising:
displaying the information corresponding to the subset of entities after detecting selection of an option to access the information.

20. A non-transitory computer readable medium for identifying prospective entities to interact with, the computer readable medium comprising computer executable instructions for:
providing a user interface via a display;
determining a plurality of entities located within a geographic area;
filtering the plurality of entities using one or more filtering criteria to determine a subset of entities that correspond to a selected type of entity;
obtaining via a communications module, information corresponding to each of the subset of entities;
using the information corresponding to the subset of entities to determine, for each entity, a ranking of being a prospective entity to interact with;
identifying one or more of the subset of entities in the user interface, in association with the geographic area; and
enabling contact to be initiated with a selected one of the one or more of the subset of entities via the communications module.
